(19) United States
(12) Patent Application Publication
(10) Pub. No.: US 2022/0060335 A1
(43) Pub. Date: Feb. 24, 2022

(54) METHOD FOR CREATING A BLOCKCHAIN DIGITAL IDENTITY, BASED ON AN ELECTRONIC SIGNATURE

(71) Applicants: SIGNE,S.A., Madrid (ES); NODALBLOCK,S.L., Madrid (ES)

(72) Inventors: Antonio PINEDO HOYVIK, Madrid (ES); Miguel Angel CARMONA TAMAYO, Madrid (ES); Andrés VAZQUEZ SANCHEZ, Madrid (ES); Teodoro SANCHEZ JIMENEZ, Madrid (ES); Carina ESTRADA VILLEGAS, Madrid (ES); María José MARTINEZ VIVAS, Madrid (ES); Ariano HERNANDEZ HUERTA, Madrid (ES)

(73) Assignees: SIGNE,S.A., Madrid (ES); NODALBLOCK,S.L., Madrid (ES)

(21) Appl. No.: 17/275,390

(22) PCT Filed: Sep. 12, 2018
(86) PCT No.: PCT/ES2018/070595

§ 371 Date: Mar. 11, 2021

(51) Int. Cl. H04L 9/32

(52) U.S. Cl. CPC H04L 9/3234; H04L 9/3263; H04L 2209/38; H04L 9/3239; H04L 9/3247

(57) ABSTRACT

A method, based on an electronic signature, for creating a blockchain digital identity, which comprises the generation of the digital identity whereby a qualified blockchain digital identity is created by merging the blockchain digital identity with the electronic signature used in each blockchain transaction, such that this digital identity can be validated.

### OBJECT OF THE INVENTION

The object of the present invention is a method for creating a digital identity which enables compliance of the blockchain identity with the regulations on electronic identification to be guaranteed, giving legal validity to the authentication and traceability of an identity in the blockchain environment.

The method enables a blockchain digital identity to be created which can be verified, thus guaranteeing the validity thereof and the compliance thereof with these regulations.

### TECHNICAL FIELD

The invention falls within the sector of electronic security in general and especially in those occasions wherein an identity is to be guaranteed in electronic transactions and blockchain documents.

### BACKGROUND OF THE INVENTION

Electronic identification is the process of using the identification data of a person in an electronic format which uniquely represents a natural or legal person or a natural person who represents a legal person.

Authentication is an electronic process which makes the electronic identification of a natural or legal person, or of the origin and integrity of data in an electronic format, possible.

An electronic signature certificate is an electronic declaration that links the validation data of a signature with a natural person and confirms, at least, the name or pseudonym of that person.

An electronic signature will have a legal effect equivalent to that of a handwritten signature, according to current legislation applicable to electronic signatures in each country.

The b-KYC (blockchain—Know Your Customer) solution, for the blockchain digital identity, enables a blockchain digital ID to be obtained from a biometric and document identification system that combines Artificial Intelligence (AI) with a revolutionary algorithmic system. With b-KYC, we guarantee reliability and security in digital onboarding by using the authenticity of the official National Identity Document (or passport), proof the person is alive and the three-dimensional biometric facial analysis as an effective anti-impersonation measure.

The electronic signature guarantees the identity of the signer of a document and the authentication on any electronic platform, but it is not capable by itself of guaranteeing the transaction and the immobility of the document.

The digital identity in the blockchain technology guarantees the transaction and the immutability of the document, but it is not capable of guaranteeing by itself compliance with the regulations on electronic identification of the owner of the document and/or transaction.

With the method proposed in the present invention, a blockchain digital identity is created which is associated with the electronic signature, which is able to be validated and, therefore, which guarantees compliance with the regulations on electronic identification of the owner of the document and/or transaction.

### DESCRIPTION OF THE INVENTION

In order to guarantee the traceability and immutability of the document as well as compliance with the regulations on electronic identification of the owner of the transaction and/or document, the merging between the electronic signature digital identity and the blockchain digital identity is presented which we call the qualified blockchain digital identity.

The proposed method is based on the use of the association of the two types of identities in the following manner:

### Creation of the QUALIFIED BLOCKCHAIN DIGITAL IDENTITY

1. Generation of an electronic signature certificate, according to the requirements of the current legislation applicable to electronic signatures in each country, which guarantees the identity of a natural or legal person.
2. Generation and custody in the same process of a symmetrical key without expiration, in the FIPS 140 level-3 HSM (Hardware Security Module).
3. Custody of the relationship between the electronic signature certificate and the symmetrical key, encoded with the master key stored in the FIPS 140 level-3 cryptographic hardware (HSM).
4. Creation of a blockchain identity: An identifier will be generated made up of user data (i.e., country+document type+document) which will be encoded with the symmetrical key in the FIPS 140 level-3 cryptographic hardware HSM (Hardware Security Module) and the hash thereof will be obtained. This hash will be the one that is recorded as a blockchain identity and only the end user will have it in order to perform transactions.
5. Recording in the database the user data and tx-hash resulting from the transaction creating the blockchain identity, encoded with the master key kept in the cryptographic hardware. FIPS 140 level-3 HSM (Hardware Security Module).

### Signing of Documents

The user must authenticate him or herself on the platform by means of their electronic signature certificate or their blockchain identity.
If the document is signed with an electronic signature certificate, this will enable the signer to be unequivocally identified and will ensure both the integrity and the non-repudiation of the signed document.
The user will perform the blockchain signature which will link the previously signed document with the QUALIFIED BLOCKCHAIN DIGITAL IDENTITY.
Every time the user performs a transaction linked to their qualified blockchain digital identity, the platform (blockchain signature engine integrated into the API generating the blockchains) will unite the data of the blockchain signature, a UTC time stamp, the identification data of the signer and their qualified blockchain digital identity and other data, such as the geolocation, if applicable.
In order to perform the transaction, a hash code of the document, based on the current algorithm, and the blockchain identity will be sent.
This hash will be recorded in the blockchain network, linking the identity of the signer with the transaction and guaranteeing both the traceability and immutability of the document and the identity of the user who performed the transaction.

### Validation

To validate the transaction of the document, the document or the hash thereof is necessary. If the identity of the person who performed the transaction is to be confirmed, the identification document of that person will be necessary.

The validation is performed with the following steps:
1. If we have the document, the hash thereof will be generated with the current algorithm. We can also directly use the hash of the document.
2. With the hash of the document, the blockchain transaction will be searched for. If it exists, the data (tx_hash) of the transaction and the blockchain identity of the user who performed the transaction are obtained.
3. If the identification document of the owner has been provided, with the data obtained, a search will be performed for the tx_hash of the blockchain identity in the database and it will be confirmed that their identity document matches the one they have provided us.

To ensure that the tx_hash of the signer belongs to that identity document, the following process will be performed:
a) Regeneration of the hash of the blockchain identity (according to point 4 of the creation of the qualified blockchain digital identity of this document)
b) Validation of the regenerated hash in the blockchain network.
c) Comparison of the tx_hash collected from point 2 with the tx_hash received in point 3b. With this, it is verified that the hash is associated with the electronic signature certificate of the person according to the relationship established in the creation of the QUALIFIED BLOCKCHAIN DIGITAL IDENTITY defined in this document.

Any document or transaction performed with the digital identity of the blockchain which guarantees traceability and immutability may be related through processes of searching for the hash with the electronic signature identity, which will guarantee the electronic signature identity that guarantees the identification of the owner of said document or transaction and ensures both the integrity and the non-repudiation of the signed document.

### DESCRIPTION OF THE DRAWINGS

In order to complement the description of the features of the invention and as a preferred practical embodiment thereof, several figures are added which, by way of illustration and not limitation, represent the following:

FIG. 1 shows a diagram of the process for creating a qualified blockchain digital identity.

FIG. 2 represents a diagram of the process of a transaction with the qualified blockchain digital identity.

FIG. 3 presents a diagram of the validation of the qualified blockchain digital identity of a transaction.

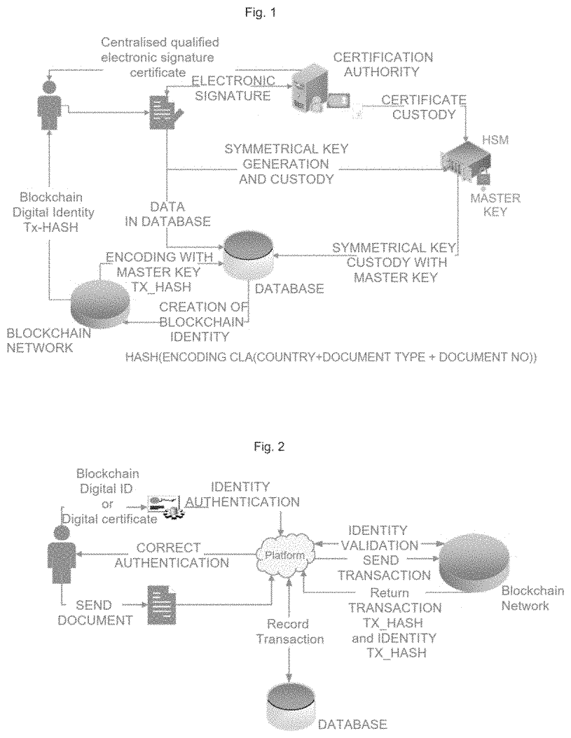

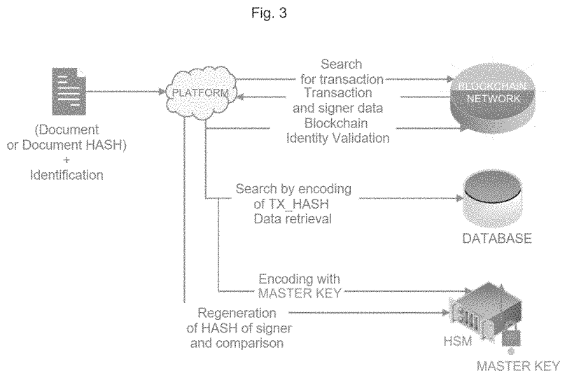

### PREFERRED EMBODIMENT OF THE INVENTION

As seen in the figures, the method for generating and validating a digital identity in blockchain transactions envisages, on the one hand, the generation of the digital identity together with the blockchain transaction with this qualified blockchain digital identity, and on the other hand, the possibility of the validation thereof.

In a preferred embodiment, the method for creating the digital identity in blockchain transactions essentially creates a qualified blockchain digital identity by merging the blockchain digital identity with the electronic signature.

This creation of the qualified blockchain digital identity is performed by means of the following steps:
generation of an electronic signature certificate, according to the requirements of the current legislation applicable to electronic signatures in each country, which guarantees the identity of a natural or legal person,
generation and custody in the same process of a symmetrical key without expiration, in the FIPS 140 level-3 HSM (Hardware Security Module),
custody of the relationship between the electronic signature certificate and the symmetrical key, encoded with the master key stored in the FIPS 140 level-3 cryptographic hardware (HSM),
creation of a blockchain identity by generating an identifier made up of user data which is encoded with the symmetrical key in the FIPS 140 level-3 cryptographic hardware HSM (Hardware Security Module) and the hash thereof is obtained which is recorded as a blockchain identity and only the end user has it in order to perform transactions,
recording in the database the user data and the tx-hash resulting from the transaction creating the blockchain identity, encoded with the master key kept in the FIPS 140 level-3 cryptographic hardware HSM (Hardware Security Module),
signing of the documents which is carried out by means of the following steps:
   i) authentication of the user on the platform by means of their electronic signature certificate or their blockchain identity,
   ii) unequivocal identification of the signer by the platform if the document is signed with an electronic signature certificate ensuring the integrity and the non-repudiation of the signed document,
   iii) the user performing the blockchain signature which links the previously signed document with the qualified blockchain digital identity.
the platform (blockchain signature engine integrated into the API generating the blockchains) uniting the blockchain signature data of a UTC time stamp, the identification data of the signer and their qualified blockchain digital identity and other data, such as geolocation, every time the user performs a transaction linked to their qualified blockchain digital identity.
sending a hash code of the document, based on the current algorithm, and the blockchain identity when performing the transaction.
recording the hash in the blockchain network which links the identity of the signer with the transaction and guarantees both the traceability and immutability of the document and the identity of the user who performed the transaction.

In this preferred embodiment, the method enables a digital identity to be created in the blockchain transactions which enables it to be validated by means of the following process:
a) if the document is available, the hash thereof is generated with the current algorithm or the hash of the document is used directly.
b) with the hash of the document, the blockchain transaction will be searched for and, if it exists, the data (tx_hash) of the transaction and the blockchain identity of the user who performed the transaction are obtained.
c) if the identification document of the owner has been provided, with the data obtained, a search is performed for the tx_hash of the blockchain identity in the database and it is confirmed that their identity document matches the one provided.

Finally, in this preferred embodiment of the creation of the digital identity, in order to ensure that the tx_hash of the signer belongs to that identity document, the following process is performed:
a) Regeneration of the hash of the blockchain identity
b) Validation of the regenerated hash in the blockchain network.
c) Comparison of the tx_hash collected in the validation with the tx_hash received in the validation in the blockchain network of the regenerated hash in the previous point.

Having sufficiently described the nature of the present invention, in addition to an example of implementation, it must be added that the steps of said invention may be modified, provided that it does not imply altering the features claimed below:

1-4. (canceled)

5. A method for creating a blockchain digital identity based on an electronic signature wherein, in generation of the blockchain digital identity, a qualified blockchain digital identity is created by merging the blockchain digital identity with the electronic signature by means of a process for generating an electronic signature certificate, generating a blockchain identity from data from a previous step and custody of a relationship between two identities with high security levels, wherein processes for creating the qualified blockchain digital identity are carried out by means of the method, said method comprising:
a) generation of an electronic signature certificate, according to the requirements of the current legislation applicable to electronic signatures in each country,
b) generation and custody in the same process of a symmetrical key without expiration, in a FIPS 140 level-3 HSM (Hardware Security Module),
c) custody of the relationship between the electronic signature certificate and the symmetrical key, encoded with the master key stored in the FIPS 140 level-3 cryptographic hardware (HSM),
d) creation of a blockchain identity by generating an identifier made up of user data which is encoded with the symmetrical key in the FIPS 140 level-3 cryptographic hardware HSM (Hardware Security Module) and the hash thereof is obtained which is recorded as a blockchain identity and only the end user has the obtained hash in order to perform transactions, and
e) recording in a database the user data and the tx-hash resulting from the transaction creating the blockchain identity, encoded with the master key kept in the FIPS 140 level-3 cryptographic hardware HSM (Hardware Security Module).

6. The method for creating the blockchain digital identity based on the electronic signature according to claim 5, wherein
the FIPS 140 level-3 cryptographic hardware HSM (Hardware Security Module) is replaced by the FIPS 140 level-4 cryptographic hardware HSM (Hardware Security Module) or the one established at the time in terms of maximum encryption security.

7. A method for creating a blockchain digital identity based on an electronic signature, said method comprising:
generating an electronic signature certificate;
generating and providing custody in a same process of a symmetrical key without expiration, in a FIPS 140 level-3 HSM (Hardware Security Module);
encoding, custody of a relationship between the electronic signature certificate and a symmetrical key, with a master key stored in the FIPS 140 level-3 cryptographic hardware (HSM);
creating a blockchain identity by generating an identifier made up of user data which is encoded with the symmetrical key in the FIPS 140 level-3 cryptographic hardware HSM (Hardware Security Module) and the hash thereof is obtained which is recorded as a blockchain identity and only an end user has the obtained hash in order to perform transactions; and
recording in a database the user data and the tx-hash resulting from the transaction creating the blockchain identity, encoded with the master key kept in the FIPS 140 level-3 cryptographic hardware HSM (Hardware Security Module).

8. The method for creating the blockchain digital identity based on the electronic signature according to claim 7, wherein
the FIPS 140 level-3 cryptographic hardware HSM (Hardware Security Module) is replaced by the FIPS 140 level-4 cryptographic hardware HSM (Hardware Security Module) or the one established at the time in terms of maximum encryption security.
